(19) United States
(12) Patent Application Publication
(10) Pub. No.: US 2002/0176969 A1
(43) Pub. Date: Nov. 28, 2002

(54) Ink jet recording medium

(75) Inventor: Jun Sugiyama, Nagano-Ken (JP)

Correspondence Address: Ladas & Parry, 26 West 61 Street, New York, NY, 10023, US

(73) Assignee: SEIKO EPSON CORPORATION

(21) Appl. No.: 10/112,077

(22) Filed: Mar. 29, 2002

(30) Foreign Application Priority Data
Mar. 29, 2001 (JP) 2001-94792
Oct. 9, 2001 (JP) 2001-311505

(51) Int. Cl. B32B 3/00

(52) U.S. Cl. 428/195; 428/207

(57) ABSTRACT

An object of the present invention is to provide an ink jet recording medium which, even when applied to gloss paper, specialty paper for ink jet recording, etc., permits the front side of the recording medium to be easily distinguished from the back side of the recording medium and, at the same time, permits the head edge of the recording medium to be easily distinguished from the rear edge of the recording medium and can maintain good appearance. In an ink jet recording medium 5 in a sheet form having an front side 51a and a back side 51b, predetermined portions 53a and 53b, in end faces 52a and 52b constituted by putting sheets of the ink jet recording medium 5 in such a manner that the front side 51a and the back side 51b are arranged in a given direction, have been colored. By virtue of this construction, the front side 51a of the ink jet recording medium 5 can be distinguished from the back side 51b of the ink jet recording medium 5.

### TECHNICAL FIELD

The present invention relates to an ink jet recording medium.

### PRIOR ART

Ink jet recording has been regarded as inferior in quality of printed images to photographic printing. In recent years, however, the advancement of an improvement in image recording apparatuses and an improvement in recording media could have resulted in the production of very high-quality images by ink jet recording.

Regarding image recording by the ink jet recording method, by virtue of an improvement in image quality in recent years, the following features inherent in the ink jet recording method have drawn attention and have been utilized.

Specifically, the features of the ink jet recording method include that: direct recording using ink can eliminate the need to complicate treatment for visualization of the image; the ink jet recording method is basically a non-contact and non-impact recording method because recording is made by the ejection of ink; since ink is deposited in only a necessary portion, ink can be utilized with high efficiency and, in addition, images having feeling of nature can be formed even on plain paper; the running cost of ink and paper is so low that the ink jet recording method is cost-effective; and color inks can be used to superimpose ink droplets, making it possible to relatively easily print a high-quality color image.

In addition to the fact that the above features have drawn attention and have been utilized, the ink jet recording method could have become utilized in various applications ranging from business fields to domestic fields by virtue of immediate formation (printing) of images and, thus, is required to be further technically improved in the future.

Under these circumstances, recording media for ink jet recording, e.g., glossy paper, on which photograph-like images can be printed by ink jet recording, and specialty paper for ink jet recording, have been provided. These glossy paper and specialty paper have been subjected to coating treatment for providing a coating, such as an ink-receptive layer or a glossiness-regulation layer on the surface of the recording paper to realize more accurately recording high-definition photograph-like images and the like. Since the cost of the coating treatment is high, the coating is generally provided on only one side of the recording medium.

Therefore, the recording surface should be specified, when the gloss paper or the specialty paper for ink jet recording is loaded into a recording apparatus. A conventional method for distinguishing the front side from the back side is as shown in FIG. 5, that is, is to write a logo mark 12 on the back side 11 which is opposite to the recording surface 10 in a recording paper 1. In this case, preferably, a construction is adopted wherein the direction of insertion into the recording apparatus can also be distinguished, that is, the head edge can be distinguished from the rear edge.

As shown in FIG. 6, the recording paper 1 is generally cut with a cutter 13 at the time of the production of the ink jet recording medium. In the head edge of the cutter 13, one side thereof is in a flat form 13a, while the other side is in a slanted form 13b. Therefore, when cutting the recording paper 1, an end edge 14, which comes into contact with the slanted face 13b, is pressed and curved by the slanted face 13b in the direction of cut movement of the cutter 13. On the other hand, an end edge 15, which comes into contact with the flat face 13a of the cutter 13, is not curved.

Therefore, for example, when piled sheets of a recording paper 1 are set in an automatic paper feeder 18 in a recording apparatus 17 (FIG. 7) with the curved end edge 14 thereof being located at the head, this sometimes causes a trouble such that the end edges 14 of the sheets of the recording paper 1 are caught by each other and, consequently, the sheets cannot be fed one by one.

Accordingly, for example, a method as shown in FIG. 7 has hitherto been adopted wherein a notch 16 is provided at the corner of the end edge 15, which has not been curved, in the recording paper 1 so that the recording paper on its side (the front or rear edge) to be first fed into the automatic paper feeder 18 in the recording apparatus 17 can be distinguished.

Pressing of the end edge 14 of the recording paper 1 in the opposite direction with a blade having the same shape as that of the cutter 13 is also considered effective for correcting the curving of the end edge 14 of the recording paper 1. In this case, however, the number of steps is increased leading to an increase in cost.

In the case of the conventional recording paper 1 provided with a logo mark 12, which enables the front side to be distinguished from the back side, however, the logo mark 12 disadvantageously deteriorates the appearance of the recording paper. The recording paper 1 provided with a notch 16 at the corner of the end edge 15, which has not been curved, so as to realize the distinguishment of the front side from the back side and the distinguishment of the head edge from the rear edge also disadvantageously has a poor appearance.

In view of the above problems, the present invention has been made, and it is an object of the present invention to provide an ink jet recording medium which, even when applied to recording media such as glossy paper and specialty paper for ink jet recording, permits the front side of the recording medium to be easily distinguished from the back side of the recording medium, permits the head edge of the recording medium to be easily distinguished from the rear edge of the recording medium, and, at the same time, can maintain good appearance.

According to the present invention, there is provided an ink jet recording medium in a sheet form comprising an front side and a back side, and a colored predetermined portion which corresponds to a portion of an end face constituted by putting sheets of the ink jet recording medium in such a manner that the front side and the back side are arranged in a given direction, whereby the front side of the ink jet recording medium can be distinguished from the back side of the ink jet recording medium, and the head edge of the ink jet recording medium with respect to the sheet feed direction in an ink jet recording apparatus can be distinguished from the rear edge of the ink jet recording medium (claim 1). The above object can be attained by this ink jet recording medium.

The predetermined portion is a portion near the corner portion of the end face along the direction of stacking rather than the center portion (claim 2).

The predetermined portion is provided near the corner portion in one face (claim 3).

The predetermined portion is provided in two faces including the corner portion along the direction of stacking (claim 4).

Furthermore, the predetermined portion is colored with a fluorescent paint which is, upon exposure to only visible light, un-visible, but, upon the exposure to ultraviolet light, emits visible light (claim 5).

As described above, the ink jet recording medium according to the present invention is characterized in that a predetermined portion of an end face constituted by putting sheet of an ink jet recording medium on top of each other or one another, in such a manner that the front side and the back side are arranged in a given direction, has been colored. In this case, the front side of the ink jet recording medium can be easily distinguished from the back side of the ink jet recording medium, for example, by setting the sheet of the ink jet recording medium in such a manner that, when the colored portion is located at the predetermined position, the top surface constitutes the front side.

Further, the head edge of the ink jet recording medium can be easily distinguished from the rear edge of the ink jet recording medium, for example, by a method wherein an end edge side, which is not curved at the time of cutting of the ink jet recording medium, is colored.

Furthermore, since only the end face constituted by putting sheets of the ink jet recording medium on top of each other or one another is colored, when only one sheet of the ink jet recording medium is taken out, the coloration of the predetermined portion is hardly recognized. Therefore, the appearance of the ink jet recording medium is not sacrificed.

When the predetermined portion is a portion near the corner portion of the end face along the direction of stacking rather than the center portion, the front side can be easily distinguished from the back side by placing the ink jet recording medium in such a manner that the corner portion on the colored side of the ink jet recording medium is located at a predetermined position.

Further, when the predetermined portion is two faces including the corner portion along the direction of stacking, the distinguishment of the front side from the back side and the distinguishment of the head edge from the rear edge can be surely and easily made even in the case where the ink jet recording medium is viewed from any direction.

Furthermore, when a fluorescent paint, such that, upon exposure to only visible light, the emission of light is not noticeable, while, upon the exposure to ultraviolet light, visible light is emitted, is used as a paint for the coloration of the predetermined portion, the fluorescent paint is not noticeable under daily visible light with the naked eye. Therefore, even in such a state that a large number of sheets of an ink jet recording medium are put on top of one another, good appearance of the ink jet recording medium can be kept.

### BRIEF DESCRIPTION OF THE DRAWINGS

FIG. 1 is a perspective view showing a first embodiment of the ink jet recording medium according to the present invention;

FIG. 2 is a perspective view showing a method for cutting an ink jet recording medium and a colored portion of the ink jet recording medium;

FIG. 3 is a perspective view showing a method for setting an ink jet recording medium in a recording apparatus;

FIG. 4 is a perspective view showing a second embodiment of the ink jet recording medium according to the present invention;

FIG. 5 is a diagram showing an example of the conventional ink jet recording medium;

FIG. 6 is a diagram showing a method for cutting an ink jet recording medium; and

FIG. 7 is a diagram showing a notch of an example of the conventional ink jet recording medium.

### EMBODIMENTS OF THE INVENTION

Embodiments of the present invention will be described in detail with reference to the accompanying drawings.

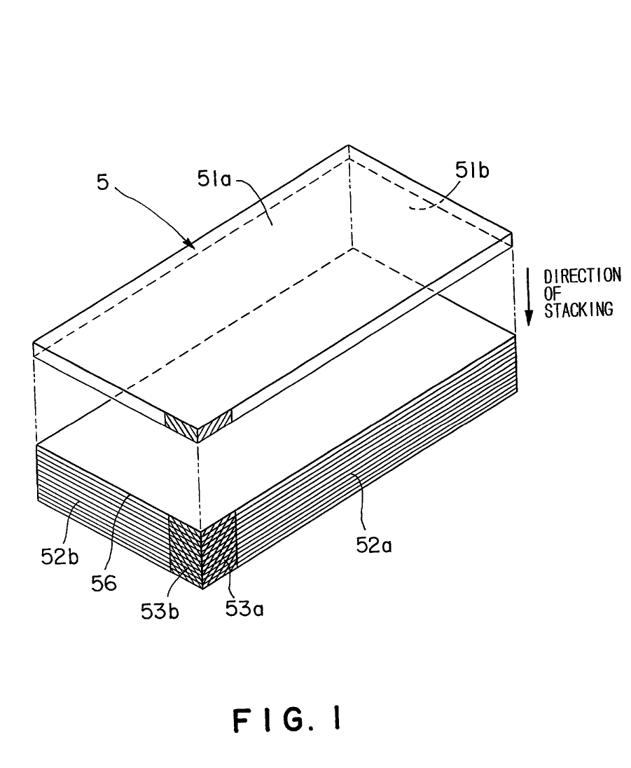

FIG. 1 is a perspective view showing the first embodiment of the ink jet recording medium according to the present invention.

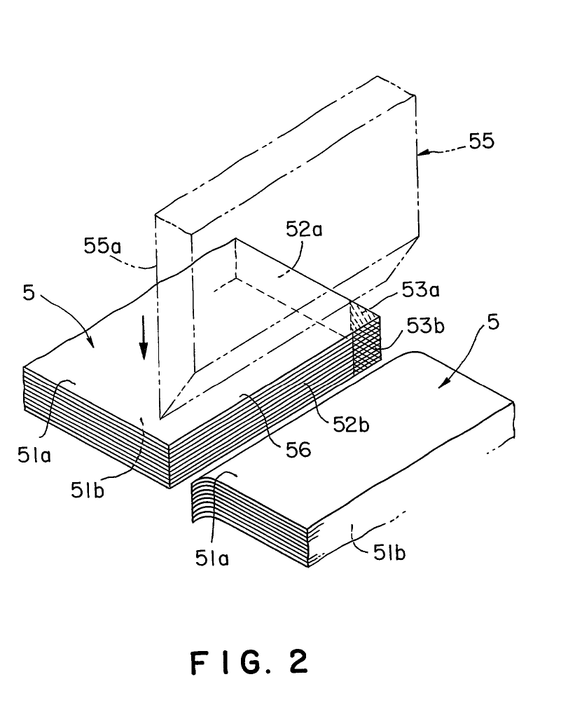

FIG. 2 is a perspective view showing a method for cutting an ink jet recording medium and a colored portion of the ink jet recording medium.

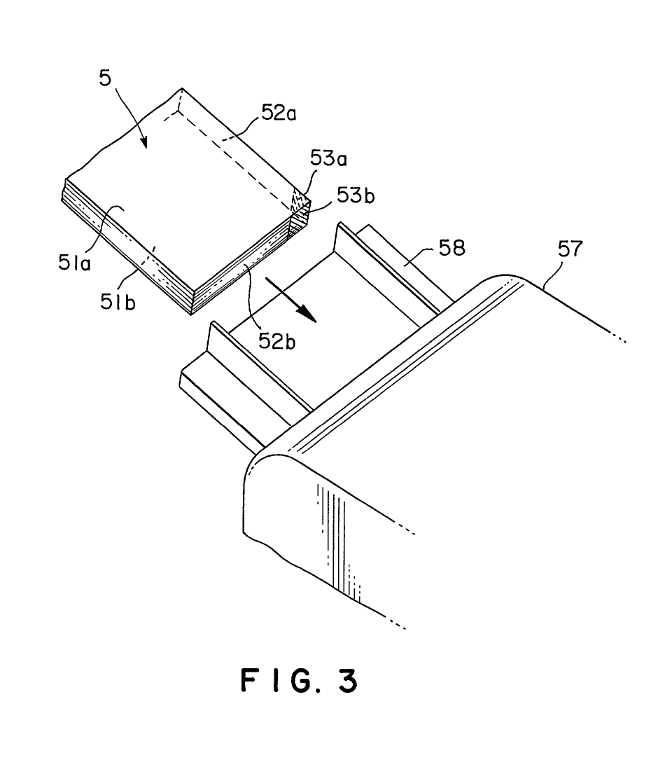

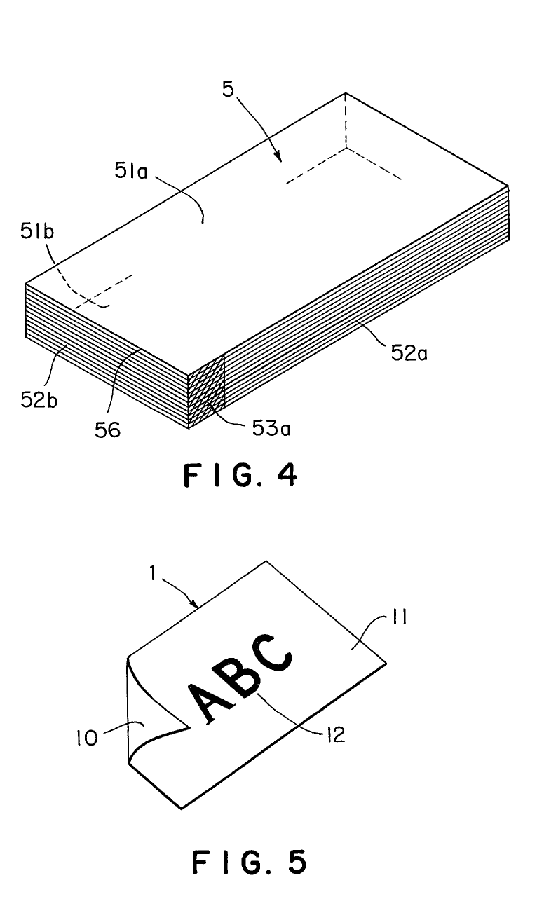

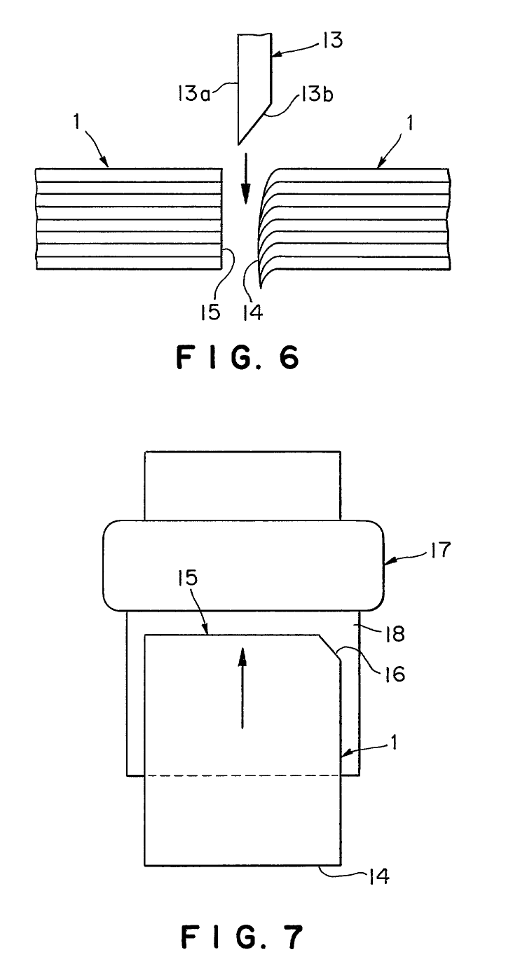

FIG. 3 is a perspective view showing a method for setting an ink jet recording medium in a recording apparatus.

FIG. 4 is a perspective view showing a second embodiment of the ink jet recording medium according to the present invention.

For example, gloss paper and specialty paper for ink jet recording, in which the front side should be distinguished from the back side, are suitable as the ink jet recording medium used in the present invention. Other recording media, for example, plain paper, resin coated paper, and OHP sheets, may also be used.

### First Embodiment

The first embodiment will be described.

As shown in FIG. 1, an ink jet recording medium 5 according to the first embodiment, to which the present invention has been applied, is in the form of a sheet, has a front side 51a and a back side 51b, and, has on its front side 51a, a coating such as an ink-receptive layer or a glossiness-regulation layer so that a high-quality image can be recorded on the front side 51a. The coating, however, is not provided on the back side 5b.

In this ink jet recording medium 5, as shown in FIG. 1, predetermined portions 53a and 53b respectively in end faces 52a and 52b constituted by putting a large number of sheets on top of one another, in such a state that the front side 51a and the back side 51b are arranged in a given direction, are colored.

In this embodiment, two faces 52a and 52b including the corner portion along the direction of stacking of the ink jet recording paper 5 are selected as the predetermined portions 53a and 53b to be colored. Therefore, when only one sheet of the ink jet recording medium 5 is taken out, the coloration of the predetermined portions 53a and 53b is hardly recognized.

As shown in FIG. 2, the colored predetermined portions 53a and 53b are provided on an end edge which, when cutting is made with a cutter 55 at the time of the production of the ink jet recording medium 5, comes into contact with a flat portion 55a in the cutter 55, that is, on the side of an end edge 56 which is not curved by the cutter 55 upon cutting.

Thus, in the ink jet recording medium 5 according to this embodiment, since predetermined portions 53a and 53b respectively in end faces 52a and 52b constituted by stacking a large number of sheets are colored, the front side 51a can be easily distinguished from the back side 51b by a method which will be described later.

Specifically, as shown in FIG. 1, in such a state that a large number of sheets of the ink jet recording medium 5 are put on top of one another, when the colored predetermined portions 53a and 53b are arranged so as to locate at respective predetermined positions, the front side 51a can be easily distinguished from the back side 51b, for example, by setting the sheets of the ink jet recording medium in such a manner that the top surface constitutes the front side 51a.

Further, the coloration of predetermined portions 53a and 53b on the end edge 56 side not curved in the ink jet recording medium 5 enables the head edge of the sheet to be easily distinguished from the rear edge of the sheet. Therefore, as shown in FIG. 3, when the ink jet recording medium 5 is set in an automatic sheet feeder 58 in a recording apparatus 57, for example, a printer, since the head edge is not erroneously regarded as the rear edge, a trouble can be eliminated such that sheets of the ink jet recording medium 5 are caught by each other, making it impossible to automatically feed sheets.

The ink jet recording medium shown in FIG. 1 is an embodiment wherein the following matters have been predetermined. In the case where sheets of the ink jet recording medium are set in the automatic sheet feeder 58 shown in FIG. 3, when the colored predetermined portions 53a and 53b are on the front left side, the end edge 56, which has not been curved, is located on the sheet feed port side of the automatic sheet feeder 58. In addition, the front side 51a is located on a side such that an image is recorded by recording apparatus 57.

In this connection, it is needless to say that, when the colored predetermined portions 53a and 53b are located at other position (front right side, rear left side, or rear right side), predetermination may be made in such a manner that the distinguishment of the front side from the back side and the distinguishment of the head edge from the rear edge are possible.

Further, unlike the prior art, the ink jet recording medium according to this embodiment can eliminate the need to provide any notch, and, therefore, good appearance of the ink jet recording medium can be kept. Alternatively, the curved end edge side may be colored. Also in this case, the distinguishment of the front side from the back side and the distinguishment of the head edge from the rear edge are easy.

Furthermore, when only one sheet of the ink jet recording medium 5 is taken out, the coloration of the predetermined positions is not recognized. Therefore, the appearance is not sacrificed.

### Second Embodiment

The second embodiment will be described.

In the first embodiment, two faces 52a and 52b in their predetermined portions 53a and 53b including the corner portion, of the end face constituted by putting sheets of the ink jet recording medium 5 on top of one another, along the direction of stacking rather than the center portion are colored. On the other hand, in the second embodiment, as shown in FIG. 4, only a predetermined portion 53a near the corner portion of one end face 52a along the direction of stacking rather than the center portion is colored.

In the second embodiment, as with the first embodiment, when sheets of the ink jet recording medium 5 are arranged so that the colored predetermined portion 53a is located at a predetermined position, the front side 51a can be easily distinguished from the back side 51b. At the same time, the head edge can be easily distinguished from the rear edge, and, in addition, good appearance of the ink jet recording medium can be kept.

The colored predetermined portion may be a predetermined portion near the corner portion of one end face 52b, in the short side of the ink jet recording medium 5, along the direction of stacking rather than the center portion.

When a fluorescent paint (a paint such that, upon exposure to only visible light, the emission of light is not noticeable, while, upon the exposure to ultraviolet light, visible light is emitted) is used as a paint for the coloration of the predetermined portion in the first and second embodiments, upon the application of ultraviolet light to the colored predetermined portions 53a and 53b, the front side 51a of the ink jet recording medium 5 can be easily distinguished from the back side 51b of the ink jet recording medium 5 and, at the same time, the head edge of the ink jet recording medium 5 can be easily distinguished from the rear edge of the ink jet recording medium 5.

Thus, when a fluorescent paint is used, also in such a state that sheets of the ink jet recording medium 5 have been put on top of one another, good appearance of the ink jet recording medium can be kept under daily visible light.

The fluorescent paint having the above properties may be a paint containing a fluorescent dye and/or a fluorescent pigment.

Fluorescent dyes usable herein include, for example, the following fluorescent dyes manufactured by Holliday Dyes & Chemicals.

Yellow fluorescent dyes include Fluorescent Yellow AA223, Fluorescent Yellow 216, Brilliant Yellow R, Brilliant Yellow Y, Brilliant Yellow FGPN, Polychrome Brilliant 10GF, Polychrome Brilliant 10GN 400%, Marcantile Brilliant Yellow 8G 80%, and Panacryl Brilliant Flavin 10GFF.

Red fluorescent dyes include Elvaplast Fluorescent Red 2B, Elvaplast Fluorescent Red G, and Elvaplast Fluorescent Red B.

Orange fluorescent dyes include Polychrome Brilliant Orange B, Polychrome Brilliant Orange 3B, Polychrome Brilliant Orange R, and Polychrome Brilliant Orange 3R.

Green fluorescent dyes include Polychrome Brilliant Green B and Polychrome Brilliant Green 3B.

Fluorescent pigments usable herein include, for example, Fluorescent Pigment ACT, Fluorescent Pigment Z/ZT, and a fluorescent pigment paste, manufactured by DAY-GLO COLOR.

As is apparent from the foregoing detailed description, the present invention is characterized in that a predetermined portion of the end face constituted by putting sheets of an ink jet recording medium on top of one another, in such a manner that the front side and the back side are arranged in a given direction, has been colored. Therefore, the distinguishment of the front side from the back side and the distinguishment of the head edge from the rear edge are easy. Further, when only one sheet of the ink jet recording medium is taken out, the coloration of the predetermined portion is not recognized. Furthermore, since there is no need to provide any notch, good appearance of the ink jet recording medium can be kept.

When the colored predetermined portion is a portion near the corner portion of the end face along the direction of stacking rather than the center portion and is one face near the corner portion, the arrangement of sheets of the ink jet recording medium, in such a manner that the corner portion on the colored side is located at a predetermined position, permits the front side of the sheet to be easily distinguished from the back side of the sheet.

When the colored predetermined portion is provided in two faces including the corner portion along the direction of stacking, the distinguishment of the front side from the back side and the distinguishment of the head edge from the rear edge are easy even in the case where the ink jet recording medium is viewed from any direction.

Further, when a fluorescent paint, wherein, upon exposure to only visible light, the emission of light is not noticeable, while, upon the exposure to ultraviolet light, visible light is emitted, is used as a paint for the coloration of the predetermined portion, the fluorescent paint is not noticeable under daily visible light with the naked eye. Therefore, even in such a state that a large number of sheets of an ink jet recording medium are put on top of one another, good appearance of the ink jet recording medium can be kept.

What is claimed is:

1. An ink jet recording medium in a sheet form comprising an front side and a back side, and a colored predetermined portion which corresponds to a portion of an end face constituted by putting sheets of the ink jet recording medium in such a manner that the front side and the back side are arranged in a given direction, whereby
the front side of the ink jet recording medium can be distinguished from the back side of the ink jet recording medium, and the head edge of the ink jet recording medium with respect to the sheet feed direction in an ink jet recording apparatus can be distinguished from the rear edge of the ink jet recording medium.

2. The ink jet recording medium according to claim 1, wherein the predetermined portion is a portion near the corner portion of the end face along the direction of stacking rather than the center portion.

3. The ink jet recording medium according to claim 2, wherein the predetermined portion is provided near the corner portion in one face.

4. The ink jet recording medium according to claim 1 or 2, wherein the predetermined portion is provided in two faces including the corner portion along the direction of stacking.

5. The ink jet recording medium according to any one of claims 1 to 4, wherein the predetermined portion is colored with a fluorescent paint which is, upon exposure to only visible light, un-visible and, upon the exposure to ultraviolet light, emits a visible light.
